(19) United States
(12) Patent Application Publication
(10) Pub. No.: US 2022/0222269 A1
(43) Pub. Date: Jul. 14, 2022

(54) DATA TRANSFER SYSTEM AND METHOD

(71) Applicant: Advanced Techvision, LLC, Canton, GA (US)

(72) Inventor: Darren Cox, Canton, GA (US)

(21) Appl. No.: 17/575,781

(22) Filed: Jan. 14, 2022

Related U.S. Application Data
(60) Provisional application No. 63/137,580, filed on Jan. 14, 2021.

(51) Int. Cl. G06F 16/25; G06F 16/242; G06F 16/22

(52) U.S. Cl. CPC G06F 16/256; G06F 16/258; G06F 16/221; G06F 16/242

(57) ABSTRACT

The techniques disclosed herein may automatically transfer data, including big data, from one storage repository to another storage repository in an optimal and secure manner. The techniques may define an export schema corresponding to export data of an internal database, create a dynamic query based on the defined export schema, execute the dynamic query on the internal database to produce a result set including the export data, export the export data in columnar format, and generate a data lake (e.g., a large data repository containing raw data) by transferring the export data to an external data lake repository.

### RELATED APPLICATIONS

This application claims the benefit of U.S. Provisional Application No. 63/137,580 filed Jan. 14, 2021, which is hereby incorporated herein by reference.

### BACKGROUND

Business intelligence (BI), which may include technologies and techniques for data analysis and/or management of business information, may be used by enterprises to gain insights that support various business decisions (e.g., legal, operational, strategic, etc.). Exemplary BI technologies and strategies may include reporting, analytics, data mining, business performance management, predictive analytics, and the like.

While some BI technologies and techniques may be implemented internally to process enterprise data (e.g., a conventional internal report server for performing analytics on data for enterprise reporting), some enterprise data may not be able to be processed internally, and, as such, the enterprise may look to external data processing providers for data processing solutions.

One example where an enterprise may use external data processing providers relates to enterprise “big data,” which may be described as large enterprise data sets that cannot be processed, and/or efficiently processed, using conventional enterprise internal processing techniques. Since the enterprise cannot internally process big data and/or cannot internally process big data efficiently, the enterprise may utilize an external data processing provider to process the enterprise big data.

However, there are some drawbacks associated with using external data processing providers. For example, data mobility between the enterprise and the external data processing provider is complex and/or suffers from limited data transfer options. Additionally, conventional data transfer techniques may not be secure, which leaves the enterprise data vulnerable to access by unauthorized parties.

### SUMMARY

The present disclosure describes novel techniques for automatically transferring data, including big data, from one storage repository to another storage repository in an optimal and secure manner. For example, the techniques may allow data stored in an enterprise's internal storage repository to be automatically transferred to an external storage repository in an optimal and secure manner.

The techniques described herein may find particular application in the field of BI for enterprise data. For example, the techniques disclosed herein may be applied to automatically transfer enterprise data to an external storage repository on a recurring basis, and, once the data is in the external storage repository, the data may be accessed for various BI technologies and/or techniques.

A particularly good candidate for these techniques may be an enterprise looking to offload internal data processing and data equipment, automate data transfers, optimize data transfers, enhance data security related to data transfers, and/or improve data preparation for BI purposes.

Adding the techniques to an enterprise setting may reduce costs associated with complex manual data transfers by providing an automated mechanism to transfer data to an external storage repository according to an enterprise-implemented schedule, reduce storage costs and data querying costs by, inter alia, optimizing a format of the data to be transferred, enhance security by transferring the data over secure data communication links, and/or allow enterprise data to be selectively prepared for particular BI purposes.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a block diagram of an exemplary embodiment of a data transferor for automatically transferring data from one storage repository to another storage repository in an optimal and secure manner.

FIG. 2 illustrates an exemplary operating environment of the data transferor.

FIG. 3 illustrates a flow diagram of an exemplary data transfer process.

FIG. 4 illustrates a flow diagram of another exemplary data transfer process.

FIG. 5 illustrates an exemplary Apache Parquet DataTable application programming interface (API) process flow.

FIG. 6 illustrates an exemplary entity relationship model of a database schema in accordance with the techniques of the present disclosure.

FIG. 7 illustrates a block diagram of an exemplary data lake serverless architecture.

FIG. 8 illustrates a block diagram of an exemplary machine for automatically transferring data from one storage repository to another storage repository in an optimal and secure manner.

### DETAILED DESCRIPTION

The techniques presented herein may provide for automatically transferring data, including big data, from one storage repository to another storage repository in an optimal and secure manner. To accomplish this, the techniques may allow optimized customizable data extractions of data contained in a source database to occur on an automated basis.

Key parts may include defining an export schema corresponding to export data of an internal database, creating a dynamic query based on the defined export schema, executing the dynamic query on the internal database to produce a result set including the export data, exporting the export data in columnar format, and generating a data lake (e.g., a large data repository containing raw data) by transferring the export data to an external data lake repository.

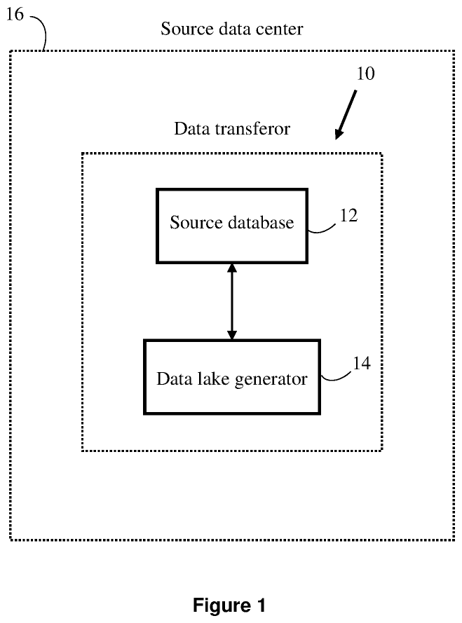

FIG. 1 illustrates a block diagram of an exemplary embodiment of a data transferor 10 for automatically transferring data, including big data, from one storage repository to another storage repository in an optimal and secure manner.

The data transferor 10 may include a source database 12 and a data lake generator 14, which may also be referred to as a centralized storage repository generator. The source database 12 and the data lake generator 14 may be located internally within a source data center 16. For example, the source data center 16 may be an on-premises enterprise data center, and the source database 12 and the data lake generator 14 may be located in the on-premises enterprise data center and may be implemented with on-premises software, hardware, and other infrastructure necessary for the software to function established within the enterprise's internal data system.

In the example of FIG. 1, the source database 12 and the data lake generator 14 may interact with one another to transmit and/or receive data. The source database 12 may store enterprise data (e.g., enterprise big data, client data, transaction data, vendor data, etc.), and BI technologies and techniques may be used on the data for various purposes (e.g., enterprise reporting, analytics, etc.) to gain insights and knowledge related to the enterprise data.

The source database 12 may be a relational database maintained by a relational database management system (RDBMS). The source database 12 may support any structured query language (SQL)-based relational database management system (RDMS) (e.g., MySQL, MS SQL, SQLite, PostgreSQL, etc.).

The data lake generator 14 may be a computer program that “runs in the background” (e.g., a computer program that performs background tasks and/or executes long-running processes, such as, for example, a non-user interface (non UI) application, a Windows® (mark of Microsoft Corporation) service application, etc.) that may automatically transfer data from the source database 12 to an external storage repository in an optimal and secure manner.

Some exemplary improvements provided by the data lake generator 14 may include improving the speed and efficiency of the underlying computer executing the data lake generator 14, reducing processing needs and memory usage of the underlying computer device executing the data lake generator 14, and enhancing data security related to the underlying computer executing the data lake generator 14 through, inter alia, allowing customizable extraction options, optimizing data formats, and using secure data communication techniques.

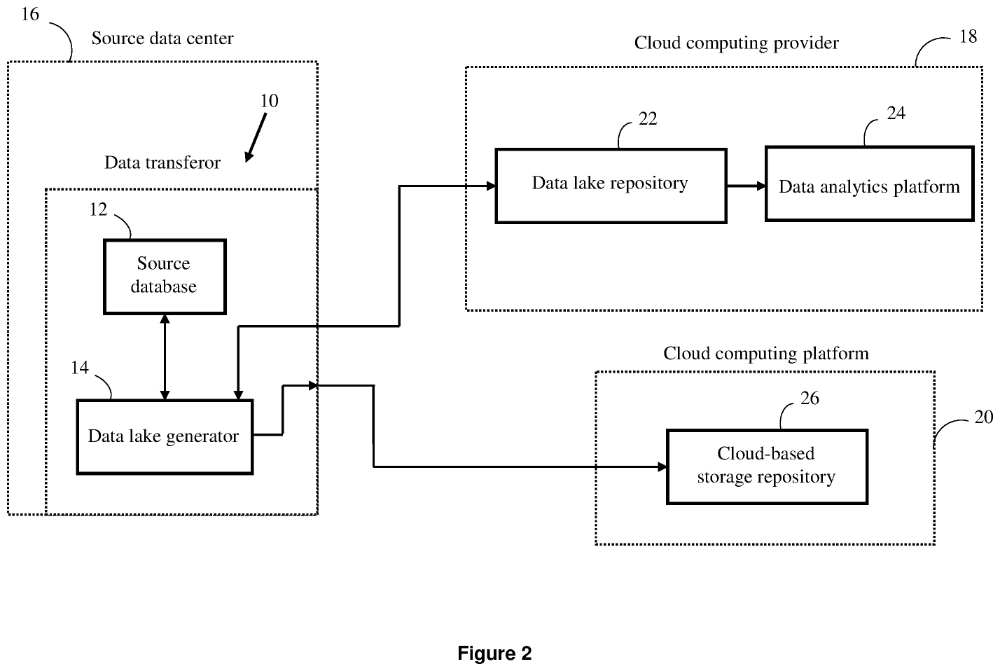

FIG. 2 illustrates an exemplary operating environment of the data transferor 10. In the example of FIG. 2, the operating environment includes an external cloud computing provider 18 and an external cloud computing platform 20. The external cloud computing provider 18 may include an external cloud-based data lake repository 22 and a data analytics platform 24. The external cloud computing platform 20 may include an external cloud-based storage repository 26.

An exemplary cloud computing provider 18 may be an Azure® (mark of Microsoft Corporation) data center, an exemplary cloud computing platform 20 may be an Amazon Web Services® (mark of Amazon Web Services, Inc.) cloud computing platform, an exemplary external cloud-based data lake repository 22 may be an Azure® data lake platform, an exemplary cloud-based data analytics platform 24 may be an Azure® Databricks data analytics platform, and an exemplary external cloud-based storage repository 26 may be an Amazon S3® (mark of Amazon Web Services, Inc.) cloud-based storage repository.

Generally, the data lake generator 14 may automatically obtain customized export data from the source database 12, export the customized export data in columnar format (i.e., an optimized format) based on an export mapping definition, and generate a data lake by transferring the optimized export data to the external data lake repository 22 of the cloud computing provider 18 over secure communication links (e.g., Hypertext Transfer Protocol Secure (HTTPS) connections, which do not require public SQL ports to be open as other conventional data transfer systems require to access the client database.

Exemplary benefits provided by the customization and optimization of the data lake generator 14 may include significant cost savings related to storage costs and query costs as less storage is needed, and faster query times related to analyzing the exported data are provided compared to conventional data transfer and storage techniques and/or systems, provide enhanced security, and eliminate the need for a report server by shifting compute and storage of reporting analytics to an external-based data analytics solution (e.g., the data lake generator 14 provides a self-hosted data lake generating solution).

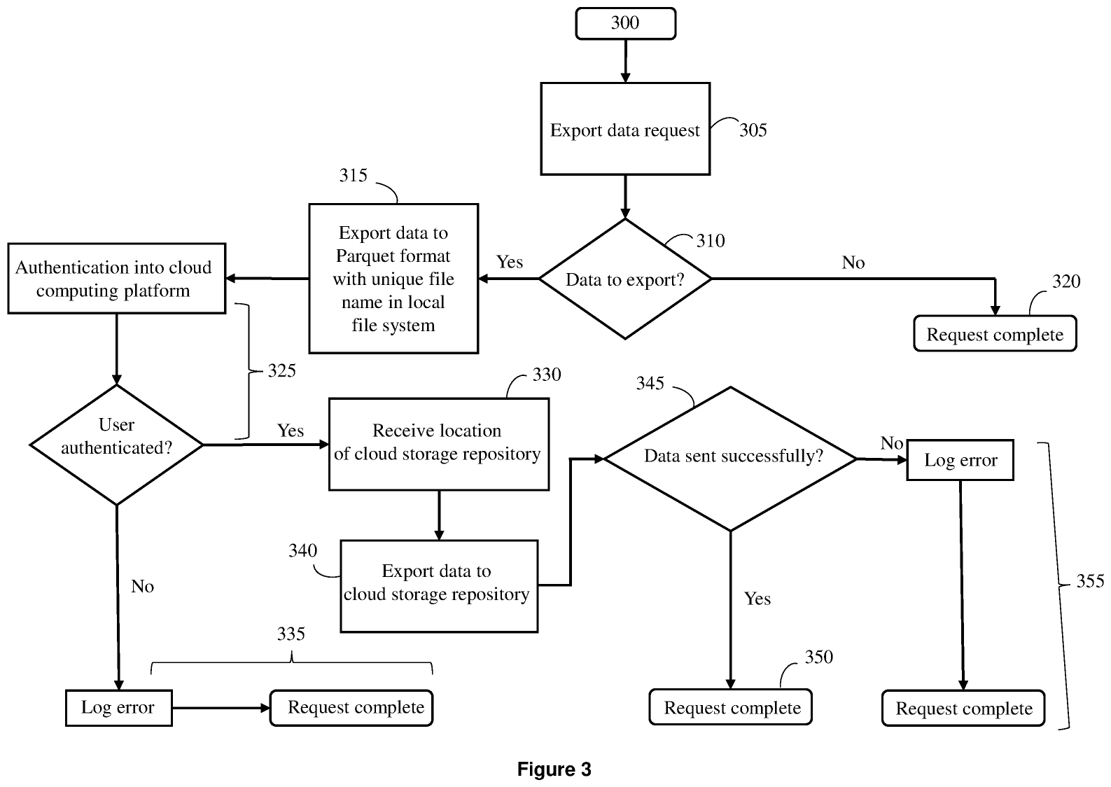

FIG. 3 illustrates a flow diagram of an exemplary method 300 for automatically transferring data, including big data, from an internal database to an external data lake repository in an optimal and secure manner.

At 305, the method 300 may send a data export request to initiate the data transfer process. For example, the method 300 may send the data export request from the source database 12 to the data lake generator 14 to initiate the data transfer process.

At 310, the method 300 may verify that the export data exists within the internal database. The method 300 may use any suitable verification technique to verify the existence of the export data in the internal database. If yes at 310, at 315, the method 300 may construct dynamic query strings based on metadata in the internal database and, based on options associated with the export data, may run the dynamic query strings, organize the export data within an Apache Parquet (Parquet) format, categorize the organized export data by a unique file name, and store the organized export data to an internal (e.g., local) file system. If no at 310, at 320, the method 300 may complete the request (e.g., end the data transfer process) and dispose of used resources.

At 325, the method 300 may initiate an authentication request to an external cloud computing platform requesting access to an external cloud-based storage repository of the cloud computing platform to authenticate the export data into the external cloud-based storage repository.

In response to authentication by the cloud computing platform, at 330, the method 300 may receive a location of the external cloud-based storage repository. In response to no authentication being provided by the cloud computing platform, at 335, the method 300 may log an error, complete the request, and dispose of used resources.

At 340 the method 300 may authenticate the organized export data into the external cloud-based storage repository of the external cloud computing platform (e.g., export the export data to the cloud computing platform).

At 345, the method 300 may initiate a data transfer success inquiry request to the external cloud computing platform. If yes at 345, at 350, the method 300 may compete the request and dispose of any used resources. If no at 350, the method 300 may log an error, complete the request, and dispose of used resources.

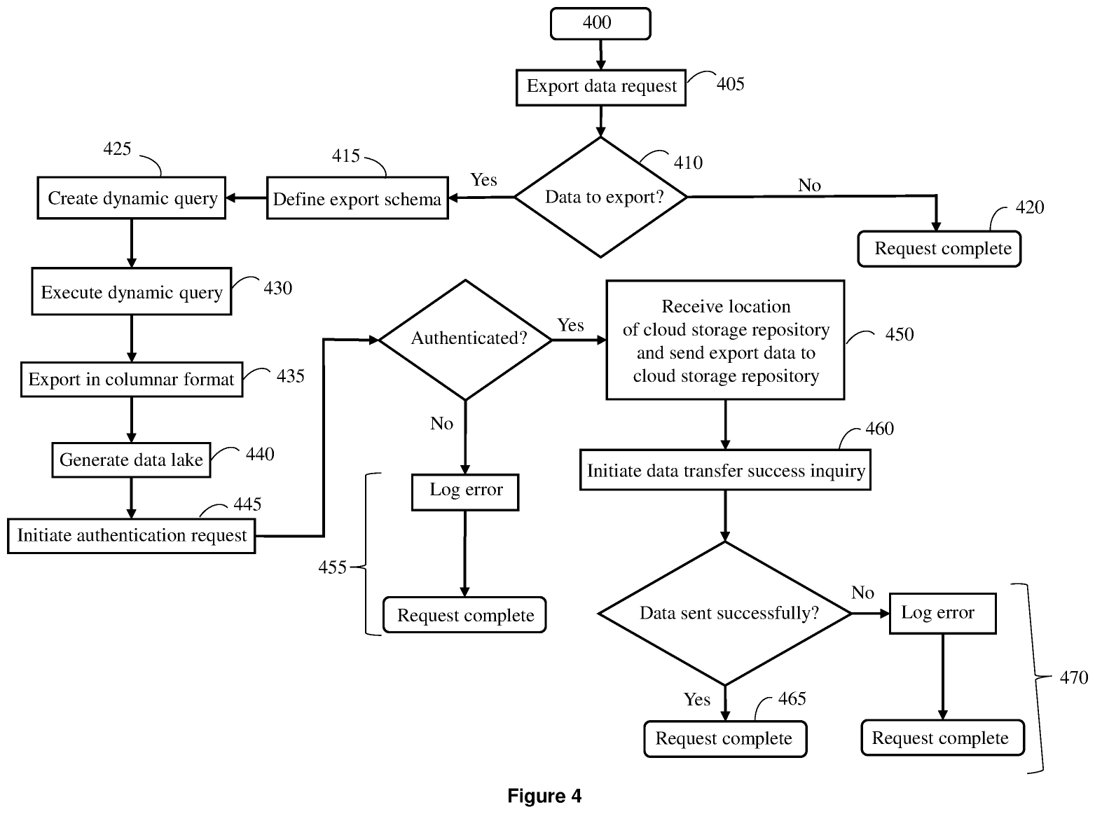

FIG. 4 illustrates a flow diagram of another exemplary method 400 for automatically transferring data, including big data, from an internal database to an external data lake repository in an optimal and secure manner.

At 405, the method 400 may send a data export request to initiate the data transfer process. For example, the method 400 may send a data export request from an internal database to a data lake generator to initiate the data transfer process. At 410, the method 400 may verify that the export data exists within the internal database. The method 400 may use any suitable verification technique to verify the existence of the export data in the internal database.

If yes at 410, at 415, the method 400 may define an export schema corresponding to export data stored within an internal database. The internal database may be an SQL relational database and the defined export schema may be defined by a user using SQL and may include an export mapping definition corresponding to the export data.

The SQL relational database may be maintained by a relational database management system (RDBMS). The RDBMS may be a MySQL RDBMS, an MS SQL RDBMS, a PostgreSQL RDBMS, and an SQLite RDBMS. The export schema may include metadata associated with the export data and the export mapping definition may be based, at least in part, on the metadata associated with the export data.

The user-defined export schema may include at least one database object, and the export mapping definition may correspond to the at least one database object. The at least one database object may include at least a portion of data stored within the internal database, and, as such, the export data may include any or all of the data within the internal database (e.g., the at least a portion of data stored within the internal database may be an entirety of the data within the internal database.)

The at least one database object may be at least one data table and/or at least one column of at least one data table. The external data lake repository may be an external cloud-based data lake repository of a cloud computing provider, the at least one database object may be at least one of one or more data tables and one or more columns of one or more data tables, and the at least one of the one or more data tables and the one or more columns of the one or more data tables may correspond to a cloud-based analytics solution (e.g., a cloud-based reporting solution). Stated otherwise, the export data may be customized (e.g., by a user defining the export data within the internal database) and tailored toward particular data analytical techniques.

If no at 410, at 420, the method 400 may complete the request (e.g., end the data transfer process) and dispose of used resources.

At 425, the method 400 may include creating at least one dynamic query based, at least in part, on the defined export schema corresponding to the export data within the internal database (e.g., the at least one dynamic query may be at least one dynamic SQL query).

At 430, the method 400 may execute the at least one dynamic query on the internal database to produce a result set, the result set including the export data. At 435, the method 400 may include exporting the data in columnar format. The export data may be exported in the columnar format based, at least in part, on an export technique that uses the export mapping definition defined by the user when the user creates the export schema.

The export technique that may use the export mapping definition to export the export data in the columnar format may be universally compatible with all data tables. Exemplary columnar formats may include Parquet and Apache Optimized Row Columnar (ORC). The export data in the columnar format may be saved internally with a unique file name.

At 440, the method 400 may include generating a data lake by transferring the export data to an external data lake repository. The method 400 may transfer the export data to the external data lake repository by authenticating the export data into the external data lake repository using a Hypertext Transfer Protocol Secure (HTTPS) connection and at least one software development tool (e.g., Azure SDK, AWS SDK, compatible library, etc.).

At 445, the method 400 may initiate an authentication request to an external cloud computing platform having an external cloud-based storage repository where the external cloud-based storage repository is a separate (e.g., different location with a different data processing provider) cloud-based solution than the external data lake repository. If yes at 445, at 450, the method 400 may receive a location of the external cloud-based storage repository and may send the export data to the external cloud-based storage repository using an HTTPS connection and at least one software development tool (e.g., Azure SDK, AWS SDK, compatible library, etc.).

If no at 445, at 455, the method 400 may log an error and the request may be complete.

At 460, the method 400 may initiate a data transfer success inquiry request to the cloud computing platform to determine whether the export data was successfully transferred.

If yes at 460, at 465, the method 400 may complete the request and dispose of used resources. If no at 460, at 470, the method 400 may log an error, complete the request, and dispose of used resources, and the method 400 may attempt to send the export data again using the same process and/or take other corrective actions.

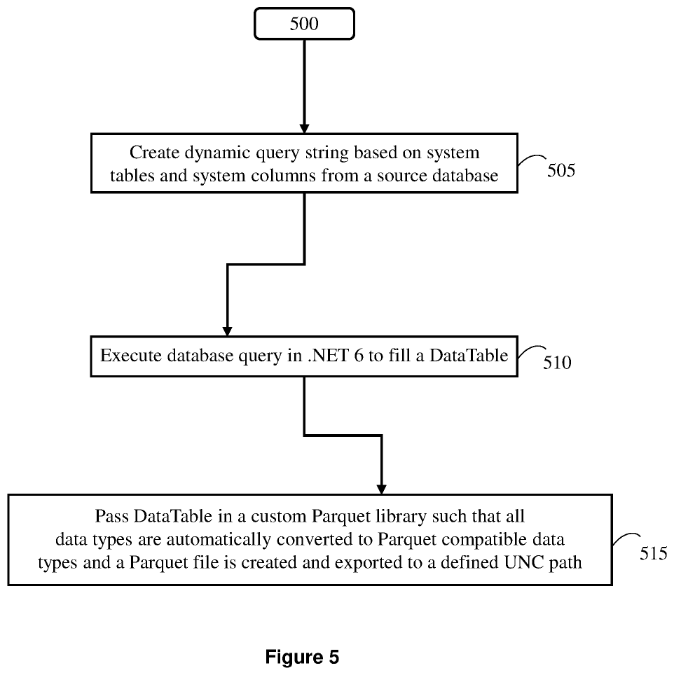

FIG. 5 illustrates an exemplary Parquet DataTable application programming interface (API) process flow. At 505, the process flow 500 may create a dynamic query string based, at least in part, on system tables and system columns from a source database. At 510, the process flow 500 may execute a database query (e.g., the dynamic query string) in a computer software framework (e.g., .NET 6) to fill a DataTable. At 515, the process flow 500 may pass the DataTable in a custom Parquet library such that all data types are automatically converted to Parquet compatible data types and a Parquet file is created and exported to a defined location in a directory structure (e.g., a defined Universal Naming Convention (UNC) path) based, at least in part, on available configuration options.

While FIG. 3 through FIG. 5 illustrate various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed and that lightweight processes, regular processes, threads, and other approaches could be employed. It is to be appreciated that other example methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional methodologies, alternative methodologies, or both can employ additional blocks, not illustrated.

In the flow diagram, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

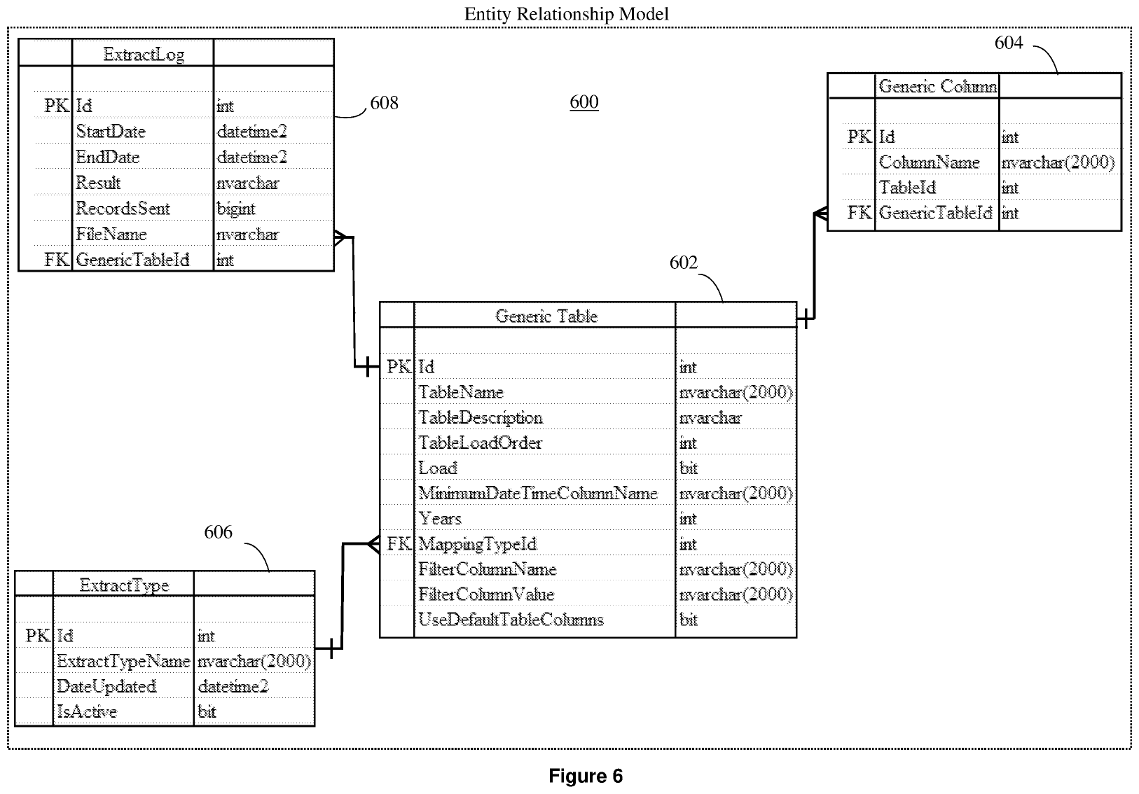

FIG. 6 illustrates an exemplary entity relationship model 600 of a database schema in accordance with the techniques of the present disclosure. The entity relationship model 600 may include a generic table entity 602, a generic column entity 604, an extract type entity 606, and an extract log entity 608. As shown in FIG. 6, many of the field elements may support dynamic code changes to support a highly configurable extract mapping corresponding to export data.

Exemplary fields that may support dynamic code changes include, inter alia, the “TableName” field of the generic table entity 602, the “ColumnName” field of the generic column entity 604, the “ExtractTypeName” field of the extract type entity 606, and the “FileName” field of the extract log entity 608.

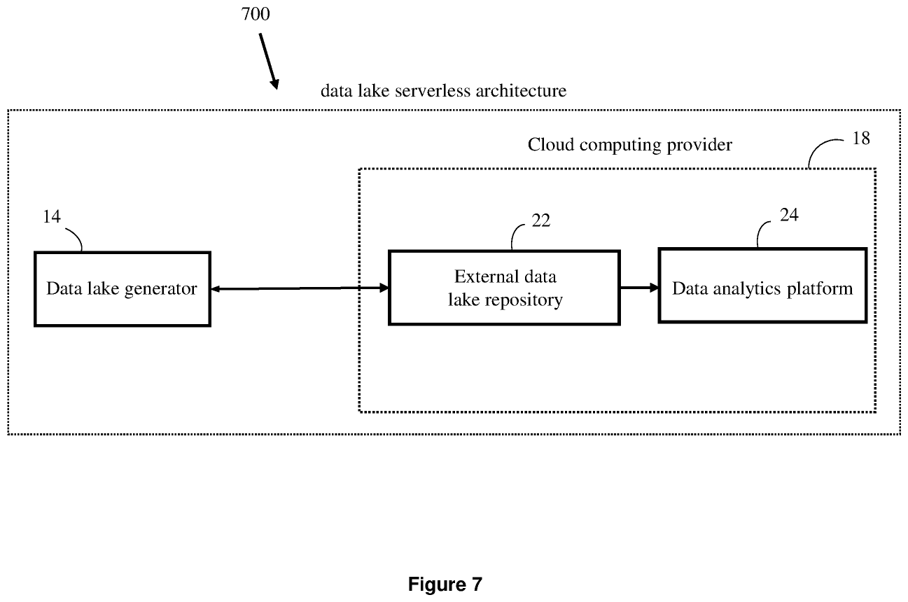

FIG. 7 illustrates a block diagram of an exemplary data lake serverless architecture 700. The data lake serverless architecture 700 may include the data lake generator 14, the external cloud computing provider 18, the external cloud-based data lake repository 22, and the external cloud-based data analytics platform 24, each of which being already described above.

In the example of FIG. 7, the data lake generator 14 may generate a data lake by transferring export data into the external cloud-based data lake repository 22 utilizing the techniques as described above. The external data analytics platform 24 may perform analytics on the data in the external cloud-based data lake repository 22 and transmit the results back to the data lake generator 14.

An exemplary implementation of the data lake serverless architecture 700 may be described where an enterprise may desire to see results of reporting analytics applied to particular data from a particular division of the enterprise. Instead of using an on-premises report server, which has to be maintained and managed by the enterprise, to perform reporting analytics on the particular data from the particular division, the enterprise may use the data lake serverless architecture 700 and the techniques of the present disclosure to perform reporting analytics on the particular data from the particular division.

More particularly, since the techniques of the present disclosure allow export data to be customized, a user of the data lake serverless architecture 700 may define the export data to include the particular data from the particular division. The techniques may export the particular data in the optimized format and transfer the export data to an external cloud computing provider to be stored in an external cloud-based data lake repository where an external cloud-based data analytics platform may access the external cloud-based data lake repository to perform reporting analytics on the particular data from the particular division.

After the reporting analytics have been completed, the results may be transmitted to the data lake generator 14 and the enterprise may access the results as needed. Exemplary benefits of using the data lake serverless architecture 700 rather than an on-premises analytics server include shifting compute and storage of analytics to the cloud, easy scalability, lower storage costs, greater amounts of storage, more computing resources, and less maintenance costs.

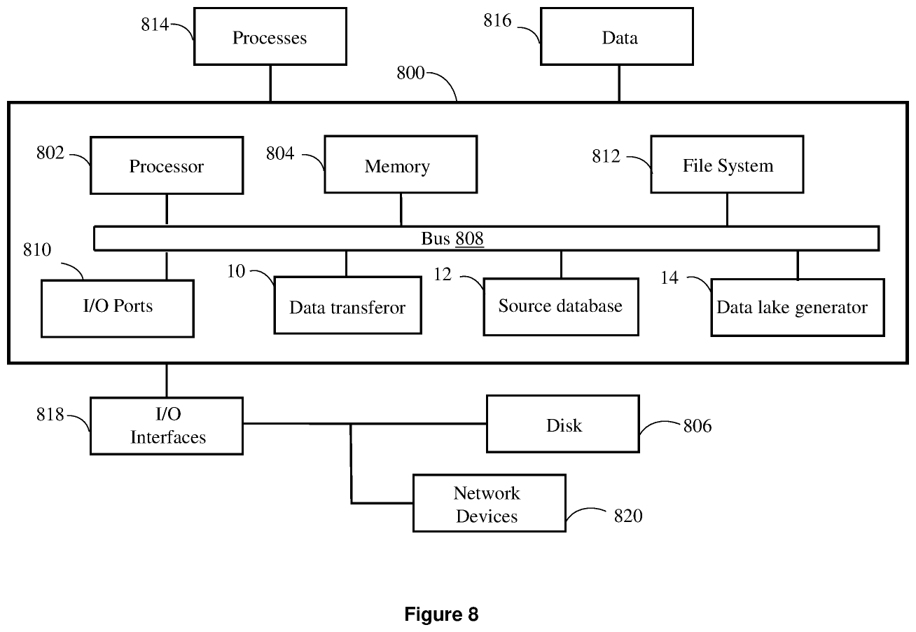

FIG. 8 illustrates a block diagram of an exemplary machine 800 for automatically transferring data, including big data, from an internal database to an external data lake repository in an optimal and secure manner. The machine 800 includes a processor 802, a memory 804, I/O Ports 810, and a file system 812 operably connected by a bus 808.

In one example, the machine 800 may transmit input and output signals via, for example, I/O Ports 810 or I/O Interfaces 818. The machine 800 may also include the data transferor 10 and its associated components (e.g., the source database 12 and the data lake generator 14). Thus, the data transferor 10, and its associated components, may be implemented in machine 800 as hardware, firmware, software, or combinations thereof and, thus, the machine 800 and its components may provide means for performing functions described herein as performed by the data transferor 10 and its associated components.

The processor 802 can be a variety of various processors including dual microprocessor and other multi-processor architectures. The memory 804 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to the machine 800 via, for example, an I/O Interfaces (e.g., card, device) 818 and an I/O Ports 810. The disk 806 can include, but is not limited to, devices like a magnetic disk drive, a solid state disk drive, a floppy disk drive, a tape drive, a Zip drive, a flash memory card, or a memory stick. Furthermore, the disk 806 can include optical drives like a CD-ROM, a CD recordable drive (CD-R drive), a CD rewriteable drive (CD-RW drive), or a digital video ROM drive (DVD ROM). The memory 804 can store processes 814 or data 816, for example. The disk 806 or memory 804 can store an operating system that controls and allocates resources of the machine 800.

The bus 808 can be a single internal bus interconnect architecture or other bus or mesh architectures. While a single bus is illustrated, it is to be appreciated that machine 800 may communicate with various devices, logics, and peripherals using other busses that are not illustrated (e.g., PCIE, SATA, Infiniband, 1394, USB, Ethernet). The bus 808 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The machine 800 may interact with input/output devices via I/O Interfaces 818 and I/O Ports 810. Input/output devices can include, but are not limited to, a keyboard, a microphone, a pointing and selection device, cameras, video cards, displays, disk 806, network devices 820, and the like. The I/O Ports 810 can include but are not limited to, serial ports, parallel ports, and USB ports.

The machine 800 can operate in a network environment and thus may be connected to network devices 820 via the I/O Interfaces 818, or the I/O Ports 810. Through the network devices 820, the machine 800 may interact with a network. Through the network, the machine 800 may be logically connected to remote devices.

The networks with which the machine 800 may interact include, but are not limited to, a local area network (LAN), a wide area network (WAN), and other networks. The network devices 820 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 820 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

In accordance with one aspect, the present disclosure may provide a method for automatically and securely transferring data to generate a data lake. The method may include creating at least one dynamic query based, at least in part, on a defined export schema corresponding to export data within an internal database, executing the at least one dynamic query on the internal database to produce a result set, the result set including the export data, exporting the export data in columnar format, and generating the data lake by transferring the export data to an external data lake repository.

The method may include internally storing the export data in the columnar format with a unique file name. The internal database may be a structured query language (SQL) relational database and the at least one dynamic query may be based on at least one dynamic SQL query. The defined export schema may be user defined and may include the export mapping definition corresponding to the export data. The method may further include using an export technique including the export mapping definition to export the export data in the columnar format. An exemplary columnar format may be Apache Parquet. The export technique, which may use the export mapping definition to export the data in the columnar format, may be universally compatible with all data tables. The defined export schema may include metadata, and the export mapping definition may be based, at least in part, on the metadata.

The user defined export schema may include at least one database object and the export mapping definition may correspond to the at least one database object. The at least one database object may include at least a portion of data of the internal database. The at least a portion of the data of the internal database may be an entirety of the data of the internal database. The at least one database object may be at least one data table and/or at least one column of at least one data table.

The external data lake repository may be an external cloud-based data lake repository of a cloud computing provider, the at least one database object may be at least one of one or more data tables and one or more columns of one or more data tables, and the at least one of the one or more data tables and the one or more columns of the one or more data base tables may correspond to a cloud-based reporting solution and/or a cloud-based analytics solution.

Before creating the at least one dynamic query, the method may send a data export request and verify that the export data exists in the internal database. The method may initiate an authentication request to a cloud computing platform including an external cloud-based storage repository where the external cloud-based storage repository may be a separate cloud-based solution from the external data lake repository, and, in response to an authentication of the authentication request and to receiving a location of the external cloud-based storage repository, the method may send the export data to the external cloud-based storage repository based, at least in part, on an HTTPS connection and at least one software development tool.

The method may use a background processing technique to automatically send the data export request. The data export request may be sent periodically (e.g., at least daily). The background processing technique may be implemented by using a non-user interface application and/or a background computer program. The method may initiate a data transfer success inquiry request to the cloud computing platform to determine whether the export data was successfully transferred. The external data lake repository may be an external cloud-based data lake repository of a cloud computing provider and the method may further include authenticating the transferred data into the external cloud-based data lake repository based, at least in part, on an HTTPS connection and at least one software development tool.

The SQL relational database may be maintained by a relational database management system (RDBMS) (e.g., a MySQL RDBMS, an MS SQL RDBMS, a PostgreSQL RDBMS, an SQLite RDBMS, etc.). The method may include internally storing the export data in the columnar format with a unique file name.

In accordance with one aspect, the present disclosure may provide a machine or group of machines for automatically and securely transferring data. The machine or group of machines may include an internal database storing export data and a data lake generator configured to create at least one dynamic query based, at least in part, on a defined export schema corresponding to the export data within the internal database, execute the at least one dynamic query on the internal database to produce a result set, the result set including the export data, export the export data in columnar format, and generate the data lake by transferring the export data to an external data lake repository.

The data lake generator may be configured to internally store the export data in the columnar format with a unique file name. The internal database may be a structured query language (SQL) relational database, the at least one dynamic query maybe at least one dynamic SQL query, the defined export schema may be user defined, the defined export schema may include an export mapping definition corresponding to the export data, and the data lake generator may be further configured to use an export technique including the export mapping definition to export the export data in the columnar format. The columnar format may be Apache Parquet. The export technique, which may use the export mapping definition to export the data in the columnar format, may be universally compatible with all data tables. The defined export schema may include metadata, and the export mapping definition may be based, at least in part, on the metadata.

The user defined export schema may include at least one database object and the export mapping definition may correspond to the at least one database object. The at least one database object may include at least a portion of data of the internal database. The at least a portion of the data of the internal database may be an entirety of the data of the internal database. The at least one database object may be at least one data table and/or at least one column of at least one data table.

The external data lake repository may be an external cloud-based data lake repository of a cloud computing provider, the at least one database object may be at least one of one or more data tables and one or more columns of one or more data tables, and the at least one of the one or more data tables and the one or more columns of the one or more data base tables may correspond to a cloud-based reporting solution and/or a cloud-based analytics solution.

Before creating the at least one dynamic query, the data lake generator may be further configured to receive a data export request and verify that the export data exists in the internal database. The data lake generator may be configured to initiate an authentication request to a cloud computing platform including an external cloud-based storage repository where the external cloud-based storage repository may be a separate cloud-based solution from the external data lake repository, and, in response to an authentication of the authentication request and to receiving a location of the external cloud-based storage repository, the data lake generator may be configured to send the export data to the external cloud-based storage repository based, at least in part, on an HTTPS connection and at least one software development tool.

The data lake generator may be configured to use a background processing technique to automatically send the data export request. The data export request may be sent periodically (e.g., at least daily). The background processing technique may be implemented by using a non-user interface application and/or a background computer program. The data lake generator may be configured to initiate a data transfer success inquiry request to the cloud computing platform to determine whether the export data was successfully transferred. The external data lake repository may be an external cloud-based data lake repository of a cloud computing provider and the method may further include authenticating the transferred data into the external cloud-based data lake repository based, at least in part, on an HTTPS connection and at least one software development tool.

The SQL relational database may be maintained by a relational database management system (RDBMS) (e.g., a MySQL RDBMS, an MS SQL RDBMS, a PostgreSQL RDBMS, an SQLite RDBMS, etc.).

In accordance with one aspect, the present disclosure may provide a non-transitory computer readable medium storing a computer program for execution by at least one processor. The computer program may include sets of instructions for creating at least one dynamic query based, at least in part, on a defined export schema corresponding to export data within an internal database, executing the at least one dynamic query on the internal database to produce a result set, the result set including the export data, exporting the export data in columnar format, and generating the data lake by transferring the export data to an external data lake repository.

The computer program may further include a set of instructions for internally storing the export data in the columnar format with a unique file name. The internal database may be a structured query language (SQL) relational database, the at least one dynamic query may be at least one dynamic SQL query, the defined export schema may be user defined, the defined export schema may include an export mapping definition corresponding to the export data, and the computer program may further include a set of instructions for using an export technique including the export mapping definition to export the export data in the columnar format. The columnar format may be Apache Parquet.

The export technique, which may use the export mapping definition to export the data in the columnar format, may be universally compatible with all data tables. The defined export schema may include metadata, and the export mapping definition may be based, at least in part, on the metadata.

The user defined export schema may include at least one database object and the export mapping definition may correspond to the at least one database object. The at least one database object may include at least a portion of data of the internal database. The at least a portion of the data of the internal database may be an entirety of the data of the internal database. The at least one database object may be at least one data table and/or at least one column of at least one data table.

The external data lake repository may be an external cloud-based data lake repository of a cloud computing provider, the at least one database object may be at least one of one or more data tables and one or more columns of one or more data tables, and the at least one of the one or more data tables and the one or more columns of the one or more data base tables may correspond to a cloud-based reporting solution and/or a cloud-based analytics solution

The computer program may further include a set of instructions for, before creating the at least one dynamic query, receiving a data export request and verify that the export data exists in the internal database. The computer program may further include a set of instructions for initiating an authentication request to a cloud computing platform including an external cloud-based storage repository where the external cloud-based storage repository may be a separate cloud-based solution from the external data lake repository, and, in response to an authentication of the authentication request and to receiving a location of the external cloud-based storage repository, the computer program may further include a set of instructions for sending the export data to the external cloud-based storage repository based, at least in part, on an HTTPS connection and at least one software development tool.

The computer program may further include a set of instructions for using a background processing technique to automatically send the data export request. The data export request may be sent periodically (e.g., at least daily). The background processing technique may be implemented by using a non-user interface application and/or a background computer program. The computer program may further include a set of instructions for initiating a data transfer success inquiry request to the cloud computing platform to determine whether the export data was successfully transferred. The external data lake repository may be an external cloud-based data lake repository of a cloud computing provider and the method may further include authenticating the transferred data into the external cloud-based data lake repository based, at least in part, on an HTTPS connection and at least one software development tool.

The SQL relational database may be maintained by a relational database management system (RDBMS) (e.g., a MySQL RDBMS, an MS SQL RDBMS, a PostgreSQL RDBMS, an SQLite RDBMS, etc.).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A machine or group of machines for automatically and securely transferring data, comprising:
an internal database storing export data; and
a data lake generator configured to:
create at least one dynamic query based, at least in part, on a defined export schema corresponding to the export data within the internal database;
execute the at least one dynamic query on the internal database to produce a result set, the result set including the export data;
export the export data in columnar format; and
generate the data lake by transferring the export data to an external data lake repository.

2. The machine or group of machines of claim 1, wherein the internal database is a structured query language (SQL) relational database; wherein the at least one dynamic query is at least one dynamic SQL query; wherein the defined export schema is user defined, the defined export schema including an export mapping definition corresponding to the export data, the data lake generator further configured to:
use an export technique including the export mapping definition to export the export data in the columnar format.

3. The machine or group of machines of claim 2, wherein the columnar format is Apache Parquet.

4. The machine or group of machines of claim 3, wherein the export technique including the export mapping definition to export the export data in the columnar format is universally compatible with all data tables.

5. The machine or group of machines of claim 2, wherein the user defined export schema includes at least one database object; and wherein the export mapping definition corresponds to the at least one database object.

6. The machine or group of machines of claim 1, wherein the data lake generator is further configured to:
before creating the at least one dynamic query, automatically receive a data export request.

7. The machine or group of machines of claim 1, wherein the external data lake repository is an external cloud-based data lake repository of a cloud computing provider; and wherein the data lake generator is further configured to:
authenticate the transferred export data into the external cloud-based data lake repository; wherein the transferring the export data to the cloud-based external data lake repository is based, at least in part, on an HTTPS connection and at least one software development tool.

8. The machine or group of machines of claim 1, wherein the data lake generator is further configured to:
initiate an authentication request to a cloud computing platform, the cloud computing platform including an external cloud-based storage repository; wherein the external cloud-based storage repository is a separate cloud-based solution from the external data lake repository; and
in response to an authentication of the authentication request, and in response to receiving a location of the cloud-based storage repository, send the export data to the cloud-based storage repository using an HTTPS connection and at least one software development tool.

9. A non-transitory computer readable medium storing a computer program for execution by at least one processor, the computer program comprising sets of instructions for:
creating at least one dynamic query based, at least in part, on a defined export schema corresponding to export data within an internal database;
executing the at least one dynamic query on the internal database to produce a result set, the result set including the export data;
exporting the export data in columnar format; and
generating the data lake by transferring the export data to an external data lake repository.

10. The non-transitory computer-readable medium of claim 9, wherein the internal database is a structured query language (SQL) relational database; wherein the at least one dynamic query is at least one dynamic SQL query; wherein the defined export schema is user defined, the defined export schema including an export mapping definition corresponding to the export data, the computer program further comprises a set of instructions for:
using an export technique including the export mapping definition to export the export data in the columnar format.

11. The non-transitory computer-readable medium of claim 10, wherein the columnar format is Apache Parquet.

12. The non-transitory computer-readable medium of claim 11, wherein the export technique including the export mapping definition to export the export data in the columnar format is universally compatible with all data tables.

13. The non-transitory computer-readable medium of claim 10, wherein the user defined export schema includes at least one database object; and wherein the export mapping definition corresponds to the at least one database object.

14. The non-transitory computer-readable medium of claim 9, the computer program further comprises a set of instructions for:
before creating the at least one dynamic query, automatically sending a data export request.

15. The non-transitory computer-readable medium of claim 9, wherein the external data lake repository is an external cloud-based data lake repository of a cloud computing provider; the computer program further comprises a set of instructions for:
authenticating the transferred export data into the external cloud-based data lake repository; wherein the transferring the export data to the cloud-based external data lake repository is based, at least in part, on an HTTPS connection and at least one software development tool.

16. The non-transitory computer-readable medium of claim 9, the computer program further comprises a set of instructions for:
initiating an authentication request to a cloud computing platform, the cloud computing platform including an external cloud-based storage repository; wherein the external cloud-based storage repository is a separate cloud-based solution from the external data lake repository; and
in response to an authentication of the authentication request, and in response to receiving a location of the cloud-based storage repository, sending the export data to the cloud-based storage repository using an HTTPS connection and at least one software development tool.

17. A method for automatically and securely transferring data to generate a data lake, comprising:
creating at least one dynamic query based, at least in part, on a defined export schema corresponding to export data within an internal database;
executing the at least one dynamic query on the internal database to produce a result set, the result set including the export data;
exporting the export data in columnar format; and
generating the data lake by transferring the export data to an external data lake repository.

18. The method of claim 17, wherein the internal database is a structured query language (SQL) relational database; wherein the at least one dynamic query is at least one dynamic SQL query; wherein the defined export schema is user defined, the defined export schema including an export mapping definition corresponding to the export data, the method further comprising:
using an export technique including the export mapping definition to export the export data in the columnar format.

19. The method of claim 18, wherein the columnar format is Apache Parquet.

20. The method of claim 19, wherein the export technique including the export mapping definition to export the data in the columnar format is universally compatible with all data tables.

21. The method of claim 18, wherein the user defined export schema includes at least one database object; and wherein the export mapping definition corresponds to the at least one database object.

22. The method of claim 17, further comprising:
before creating the at least one dynamic query, automatically sending a data export request.

23. The method of claim 17, wherein the external data lake repository is an external cloud-based data lake repository of a cloud computing provider, the method further comprising:
authenticating the transferred data into the external cloud-based data lake repository; wherein the transferring the export data to the cloud-based external data lake repository is based, at least in part, on an HTTPS connection and at least one software development tool.

24. The method of claim 17, further comprising:
initiating an authentication request to a cloud computing platform, the cloud computing platform including an external cloud-based storage repository; wherein the external cloud-based storage repository is a separate cloud-based solution from the external data lake repository; and
in response to an authentication of the authentication request, and in response to receiving a location of the external cloud-based storage repository, sending the export data to the external cloud-based storage repository using an HTTPS connection and at least one software development tool.
